(19) United States
(12) Patent Application Publication
(10) Pub. No.: US 2012/0275526 A1
(43) Pub. Date: Nov. 1, 2012

(54) ETHERNET OVER POWER

(76) Inventor: Glyn Hughes, London (GB)

(21) Appl. No.: 13/405,007

(22) Filed: Feb. 24, 2012

(30) Foreign Application Priority Data
Aug. 24, 2009 (GB) GB 0914681.2
Aug. 24, 2010 (GB) PCT/GB2010/001593

(51) Int. Cl. H04B 3/54

(52) U.S. Cl. 375/257

(57) ABSTRACT

The present disclosure relates to Ethernet-over-Power and provides communication to and from the powerline hardware, e.g. power sockets or light fittings, and through the powerline itself. In one aspect a Power and Data transmission terminal that is a MAC addressable power outlet, switch or transition point is provided, the Power and Data transmission terminal having a PLC Transceiver, a microcontroller, a power consumption meter and a transmission router between the microcontroller and the PLC Transceiver, the system thereby being able to both monitor energy usage and allow data communication over the powerline with a single microcontroller at the or each Power and Data transmission terminal. The system provides I. P addresses to the electrical outlets from which a wide range of devices run and in so doing it can communicate with the electrical outlets themselves.

### FIELD OF THE INVENTION

The present invention concerns improvements in and relating to Ethernet-over-Power and provides communication to and from the powerline hardware, e.g. power sockets, and through the powerline itself.

### BACKGROUND TO THE INVENTION

Ethernet-over-Power adaptors, or Internet Protocol (IP)-over-power adaptors as they are alternatively known, have been in existence for the past 20 years. Such adaptors plug into power sockets and modulate low voltage data signals in order that they can be transmitted along medium voltage power cabling thereby providing an opportunity to reduce the need for dedicated (twisted pair) data cabling to be installed/used and providing a more secure alternative or supplement to wireless data transmission in Local Area Network (LAN) systems. Electrical cable is generally more stable than twisted pair cable and has the potential to offer great benefits Some grand IP-over-Power proposals have also been made in the company side of the electricity system where the cables are much thicker and adapted to carry electricity at over 1 kV. These were either Wide Area Networks or local to the supplier only and so far have only had limited take-up.

Though ethernet-over-Power systems have had little uptake initially, there are now a number of limited scope LAN systems in use in the domestic/small office market sector. These mostly comprise a plurality of plug-in Ethernet adaptors each having the form of an electrical plug to be inserted into a ring mains socket (240V three pin wall-mounted socket in the UK) to inject data-streams into the ring mains power supply network of the home or office and facilitate communication thereby to and from the appliances connected to them. Such systems do not, however, serve more than a very localized area within the ring main and are not equipped to serve any power management functions.

The applicants of the present application have developed a new system that can operate as an Ethernet over Power system but also as an energy management system. An objective of the present invention is to utilize a single infrastructure for all transmission applications, power or data, and reduce the financial and ecological impact of buildings. A further, primary, objective is to unlock the communication potential of power cable to monitor and analyse the very energy that it propagates, in order to remotely manage and conserve energy within the building.

Objectives include: a) to create a system for efficiently controlling and managing the use of electrical energy; and b) to create communication with and or control diverse devices attached to the power line,

The combination of inventions disclosed in the present application seeks to create a unified communications system, the ‘central nervous system’ of intelligent buildings, principally by harnessing the communications potential of power cable indigenous to every building, (and whose network reaches to the heart of every electrically powered device) but also compatible with and able to communicate through any other physical layer (1) standard of OSI model such as, but not limited to, Fibre, Coaxial or Twisted Pair and or any Wireless Access Platform for Electronic Communications Services Management (WAPECS) band or Bluetooth or Infra Red or any other wireless communication standard.

Whereas limited scope PLC data communications networks exist that use plug in adaptors these are uni-functional and generally inefficient. Energy monitoring and information systems—(smart metering systems)—do also exist but are limited in scope to either whole house or single appliance information and existing control systems designed to switch on/off addressed sockets are all very limited in scope, as are existing systems designed to mitigate energy use by allowing the user to turn off the socket through infrared during standby.

None of the existing Ethernet-over-Power systems are able to satisfy multiple system applications and problems of the above type and users are generally left opting for one set of functionality or another. Accordingly it is an object of the present invention to provide a multi-functional system that brings together combinations of a data communications system, an energy monitoring and control system, an energy saving system, preferably even a fire safety system, and a communications network that provides a physical layer platform between all Ethernet based devices.

Existing systems have been uni-functional in part because user datacomm transmission and energy and control transmissions each have different transmission sources and there can only be one comms chipset in any plug or socket otherwise it would be too expensive to produce and there would be transmission conflicts between the two comms micro processors. Notably for this reason, other than PLC plug in adaptors, none of the existing intelligent sockets have RJ45 interfaces. The same problem exists at a lower level—two data sources in conflict attempting to communicate with one comms microprocessor. Systems to date therefore have been designed with one data source in mind and that along with the design intention of solving a single problem has made them essentially uni-functional. To access even a major part of the different functionalities of existing uni-functional systems would necessitate at least two but possibly three different systems to be installed in a user's premises, the expense and logistics of which would be prohibitive.

### SUMMARY OF THE INVENTION

The inventions set forth hereinafter are intended to cover all classifications of voltage in all countries, the system is intended to work with all domestic and commercial voltage requirements worldwide. For the purpose of this document UK voltage standards will be used as an example and, for the purpose of this document: i) High voltage means >600 v; ii) Medium voltage means 10 v-240 v; iii) Low voltage means <10 v; iv) Company side means supplier side (generally outside the building); and v) Customer side means consumer side (generally inside the building)

The ‘outlet addressed’ elements referred to hereinafter are intended to cover all examples of electrical power outlets, including but not limited to fixed wall outlets, light fittings, electrical spurs and transition points and nodes, where the intention is to communicate with the outlet and powerline. The outlet addressed element can be an electronic circuit designed to work in conjunction with a power outlet or to fit into a power outlet, or a power outlet with an electronic circuit already fitted

The ‘device addressed’ elements referred to hereinafter are intended to be fitted to all types of consumer equipment, including but not restricted to televisions, ovens, locks, refrigerators cameras, where the intention is to ‘network’ the device or communicate with the device through a power cable.

For the purpose of this document outlet addressed elements are designated as follows: Class A are appliance circuit outlets controlling for example electrical wall outlets; Class B are lighting circuit outlets controlling for example light fittings; and Class C are device outlets designed to work in conjunction with appliances, e.g TV equipment.

A major problem that the system of the present invention solves is that it integrates different types of functionality including inter alia datacomms and energy monitoring together in one multifunctional system. Unifying these functions provides the application drivers to develop new algorithms that, in the energy monitoring system for example, recognise different appliances when they are attached to the powerline. In turn this allows us to make intelligent on/off decisions for the user. The system can understand when a device is on standby for example and turn it off to save energy or when an appliance is unsafe and turn it off to avert appliance damage and or fire. The unifying of energy monitoring, energy control, data communications and audio/video communications has facilitated the design of an extraordinarily powerful and radical multi functional system.

According to a first aspect of the present invention there is provided a method of operating an interactive powerline information and control system (IPLICS) comprising of a power and data distribution network (PADN) and plurality of power and data transmission terminals (PDTT) at a range of locations, the PADN supplying low to medium voltage power at 240 v or below, the method comprising; transmitting and receiving a multiplicity of information at least in part over the powerline relating to the plurality of PDTT's and any enabled appliances (EA) connected thereto; harvesting and storing the information in a memory and analysing the harvested information, and using the harvested information to recognise specific conditions, communicate and control the PDTT's and/or any EA's attached thereto at least partially through the powerline. The Enabled Appliances are appliances linked to the PDTT's that are addressed and are alternatively referred to above as “outlet addressed elements”.

According to a further aspect of the present invention there is provided a networked system comprising cable able to carry power and data, the system supplying low to medium voltage power at 240 v or below and comprising at least one Power and Data transmission terminal that is a MAC addressable power outlet, switch or transition point, the Power and Data transmission terminal having a PLC Transceiver, a microcontroller with memory, a power consumption meter and preferably with a transmission router between the microcontroller and the PLC Transceiver, the system thereby being able to both monitor energy usage and allow data communication over the powerline with a single microcontroller at the or each Power and Data transmission terminal.

The transmission router is in use located between at least two different low level data sources allowing multi source transmissions to be received and conveyed to a single comms chipset. This configuration enables construction of a truly multifunctional and very powerful system.

Preferably the system has a control panel that has a User Interface combined with a Microprocessor that translates the information provided by the sockets into user friendly, preferably graphical, information, and operability. User-centric software/algorithms for each application forms part of the system and increase it's functionality. Each of the functions provides synergy to the other. Energy monitoring and control, for example, allows us to develop algorithms that can make decisions which allow the system itself to save energy without human intervention and provides a much more powerful smart metering product.

The control panel User Interface provides the face of, and improves and adds to the functionality of each of the applications. Information on data transfer through the communications network for example can be accessed and controlled through the User interface, different source transmissions can be routed to different areas and appliances and a myriad other tasks can be performed in a very simple way. The control panel solves the problem of fragmented and difficult to access information by putting all the information and control in one place in a user friendly way. This interface and associated processor represent further novel and inventive aspects of the present invention in their own right separately of the Power and Data transmission terminal.

The system of the present invention has power and data transmission terminals that take the place of conventional electrical power sockets and switches. It is a digitally and manually controllable fixed terminal hub that serves as a connection point for electrical transmissions, data transmissions, video and audio transmissions. A typical terminal is a wall or floor-mounted/fixed position electrical plug socket or switch unit. It suitably comprises: at least two of Electrical, RJ45, USB and Telecom interfaces, or any combination thereof; a powerline communications transceiver and or a wireless communications transceiver. The terminal is capable of transmitting power to any attached appliance and broadcasting multi sourced data, audio and video over the powerline or wirelessly. Alternatively the transmission terminal may be attached to the powerline through a power cord.

The system incorporating the power and data transmission terminal brings central and local control together in a multifaceted system suitably presented on an intuitive User Interface. The Interface can provide top down information and control—from a graphical display for example showing whole building energy consumption, cost and overall diagnostics, through floor and/or room views down to individual appliances showing the name of the appliance and diagnostics i.e that the appliance is functioning well, the user can drill down to any malfunctioning appliance anywhere in the bulding.

Central control may be carried out by a Powerline Information and Control Device with display screen and user interface (suitably with Graphic User Interface) that is centralised, remote from the various Power and Data Transmission Terminals and any linked Enabled Appliances.

Local control is also available at the Power and Data Transmission Terminals (PDTTs) by virtue of the programming of the micro-controllers of the PDTTs. These have the memory and programming to allow for a range of local control which may be substantially autonomous in nature, whereby the PDTTs may, for example, autonomously power down if over-heating or smoke is sensed or if the power drain is outside of acceptable/predetermined parameters. The control may be of closed loop type and may entail negative feedback control. The power and data transmission terminals are truly intelligent in their operation and need not rely on user intervention to respond to electrical state or environmental conditions. They can be configured to send information to and receive information from an external/remote control centre or user interface or can be programmed to respond to some sensed conditions automatically entirely locally without reference to any external/remote control centre or user interface.

History functions and average appliance consumption functions can be monitored by a processor and linked database of the system and provide instant, easy to comprehend information that allows the user to react rapidly to changing appliance or user situations and mitigate at the very earliest opportunity any appliance or human anomalies or changed circumstance.

This type of dynamic system solves many problems. Users do not have to switch off sockets individually, one touch on the user interface closes everything down, or according to the program set, automatically when you are in bed.

The networked system is suitably a LAN. A particularly preferred MAC (Media Access Control) addressable power outlet is a power socket of mains supply in a building. This is suitably at 240V or less. Another preferred MAC addressable power outlet is a light fitting of mains supply in a building. Outlets suitably comprise an electronic circuit with TCP/IP (or equivalent protocol) unique MAC addressable chip or chipset and microprocessor that enables them to be addressed by fixed addressing or roaming addressing. The MAC addressable power outlet thus has a unique MAC address in use and can be communicated with. Diverse electrical switches and transition points may also be provided with a similar outlet addressed circuit.

According to a further aspect of the present invention there is provided a networked system of cable and interconnects to carry electrical power and data the system being adapted to monitor, control and manage the power and having means to provide information on the voltage and electrical current being transmitted by the electrical network or on the power being drawn at an outlet, switch or transition point to a microprocessor/controller (intelligent ‘chipset’).

The system suitably carries medium or low voltage electrical power, the term medium voltage as used herein meaning less than 600V single phase (or less than 600V per phase for a triple phase power supply) and for most uses the voltage is 240V or less, e.g. 110V or other national or regional standard equivalent mains voltage used at the consumer end in domestic, commercial or office premises.

In general, the system may have any topology. It could be a ‘single structure system’ and may optionally use multi-conductors. The system can comprise any modular system of transmission media and interconnects able to carry power and data.

The system may be a conjoined network or system of interconnects and device outlets, to propagate and or transmit medium voltage electrical energy or a modular system of transmission, interconnects and device outlets to transmit energy and data and or telecom signals over a single circuit, or a structure encompassing multiple circuits, screened or unscreened with or without an earth component whether employing the principle of Ethernet over Power or any other principle to transmit data and power.

These features and aspects of the invention and further features and aspects are set forth in the description, claims and drawings hereinafter.

### BRIEF DESCRIPTION OF THE DRAWINGS

Preferred embodiments of the present invention will now be more particularly described by way of example and with reference to the accompanying drawings, wherein:

FIG. 1 is a schematic system architecture diagram showing a system embodying the invention as installed in a two-story residential dwelling;

FIG. 2A is a perspective view of an example appearance of an example outlet (electrical plug socket) having an integrated communications access point;

FIG. 2B is a perspective view of an outlet (electrical plug socket) that optionally also has an integrated communications access point but distinctively has an integrated ammeter;

FIG. 2C is a perspective view of an outlet (electrical plug socket) that is of an example 146×86 electrical socket hub type and has an integrated communications access socket for data cabling plus an integrated wireless communications facility;

FIG. 2D is a perspective view of an outlet (electrical plug socket) that optionally also has an integrated communications access point but distinctively has an integrated ammeter or power meter;

FIG. 3A is a schematic diagram of a circuit element comprising an addressable load detection module within a ‘standard’ mains supply outlet and which functions to monitor, store and transmit load usage data at the outlet point;

FIG. 3B is a schematic diagram of a variant of the FIG. 3A circuit element extended to have a remote switching capability whereby the element can monitor, store and transmit load usage data at the outlet point and receive and implement switch activation data;

FIG. 3C is a schematic diagram of a variant of the FIG. 3A or B circuit element extended to have a real-time digital display capability and whereby a fascia mounted display facility can display current and/or power usage and/or outlet identification;

FIG. 3D is a schematic diagram of a variant of the FIG. 3A or B or C circuit element extended to have flexible transmission capability and whereby it can monitor, store and transmit load usage data at the outlet point and receive and implement control activation data;

FIGS. 4A-C are Addressable Outlet application systems diagrams, wherein FIG. 4A is for a small single phase system (domestic/small commercial) with a single distribution board, FIG. 4B is for a medium to large, multi-zoned integral system that is multi-zonal by defined areas, floors, integral units simultaneously serviced by the same power supply, and FIG. 4C is for a multi-site remote management system; and

FIG. 5 is a functional block schematic diagram of the key features of the power and data transmission terminal of a preferred embodiment of the primary aspect of the present invention and shows the arrangement of the micro-controller 15, transmission router 16, power consumption meter 17, Ethernet input port/data interface 18, PLC (Power Line Communication) transceiver 19 and control relays 20; and

FIG. 5A corresponds to FIG. 5 but illustrates signal flows of the power and data transmission terminal by different coloured flow-lines.

### DESCRIPTION OF THE PREFERRED EMBODIMENTS

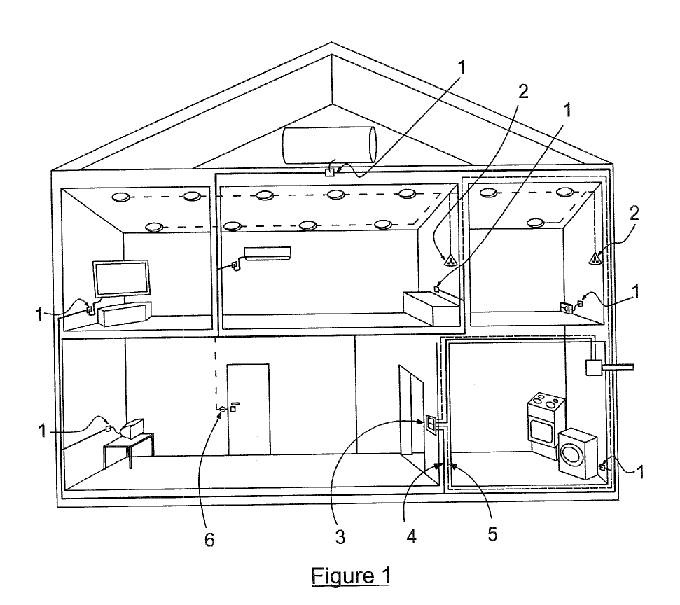

Referring firstly to FIG. 1, this shows an example system embodying the invention as installed in a two-story residential dwelling. This has a plurality of power sockets 1 for electrical plugs that are modified to be MAC addressable.

These are the ‘Class A’ IP addressable outlets and are linked by the corresponding ‘Class A’ power cabling 4. In addition to these ‘Class A’ IP addressable outlets 1 there are ‘Class B’ IP addressable outlets including those that use the lighting circuit such as the IP addressable light switches 2 illustrated in FIG. 1. A control panel 3 is provided to give control over the system and may, for example, allow control of doors to close/lock, lights to be monitored and turned off if not needed, power sockets the same et cetera. The locking of doors may use corresponding IP addressable door lock outlets 6.

To serve as examples of the ‘Class A’ IP addressable outlets embodying the first aspect of the present invention nine variants of such outlets will now be described.

### 1) Basic MAC or Physical Addressable Outlet

This may be a (fixed) medium voltage electrical wall outlet, floor outlet, electrical ‘bus bar’ or modular system outlet, transition or termination point or nodal point, or any other type of consumer side electrical outlet or switch. It may be a singular or plural outlet.

The electrical outlet has a Network Interface TCP/I.P (or equivalent protocol) unique MAC addressable chip or chipset designed to communicate with other devices over any medium voltage electrical transmission media. The communication may be by using Power Line Connectivity. Alternatively a communication may be by: any other physical layer (1) standard of OSI model such as, but not limited to, Fibre, Coaxial or Twisted Pair; and data link layer (2) standard of the OSI model such as but not limited to Ethernet, token ring or any Wireless Access Platform for Electronic Communications Services Management (WAPECS) band or Bluetooth or any other wireless communication standard. In general a primary object of transmitting the framed packets is to control the outlets and to provide information on the medium voltage power being propagated. The purpose of the MAC addressable chipset therefore is to act as a communication gateway between a remote PC or Control Panel or command centre and the outlet substance or hardware described herein.

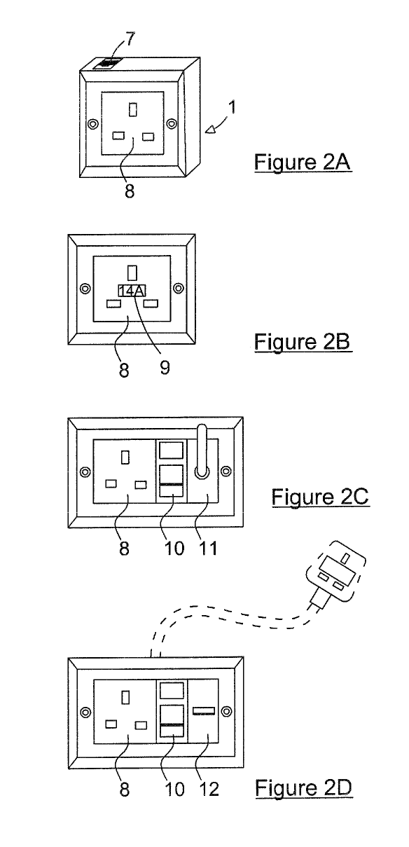

The power outlet described would preferably incorporate any type of access port or interface such as, but not limited to RJ45, USB or any other type of connection interface. An example of the outlet with interface/communications' access point 7 above the power plug socket 8 is illustrated in FIG. 2A. The interface allows a PC or any other appliance to access and communicate or make or receive a transmission of any description (other than power itself) through the powerline

2) MAC Addressable Outlet with Modulator

In a refinement of the first category of MAC addressable outlet, in the second category the outlet of the first category, either singly or in plurality, is modified to incorporate a modulation device designed to modulate/demodulate low voltage framed packet communication signals in a manner that allows the signals to be injected, transmitted, received, routed, amplified or otherwise dealt with and transmitted. The data packet is modulated/demodulated in such a way that it may be transmitted between a medium voltage (as defined earlier) electrical power-line and any device or transmission media defined as part of the physical layer (1) standard of OSI model such as but not limited to Fibre, Coaxial or Twisted Pair, and data link layer (2) standard of the OSI model such as but not limited to Ethernet and token ring or any Wireless Access Platform for Electronic Communications Services Management (WAPECS) band or Bluetooth or any other wireless communication standard where the packet is dealt with as low voltage.

3) MAC Addressable Outlet with Ammeter/Powermeter

In a third category the MAC addressable electrical outlet as described in 1&2 above, jointly, singly or in plurality incorporates an ammeter or powermeter (ammeter in conjunction with voltmeter) information from which may be provided on a display 9 (in any format, e.g. graphically or numerically) as illustrated in FIG. 2B. The powermeter may also incorporate or work in conjunction with an ohmmeter or any other type of electrical sensor or meter whose function is to provide information on electrical values or characteristics, a primary purpose of which is to measure and detect powerline/outlet performance changes in order to diagnose potential problems and to detect changes in appliance power usage e.g. when a device goes on standby

4) MAC Addressable Outlet that Incorporates a Switched Relay

In a fourth category the MAC addressable electrical outlet as described in 1&2 and 3 jointly, singly or in plurality, incorporates a relay whose function is to enable or disable the host electrical outlet as described in 1, 2, and 3 either jointly, singly or in plurality at a command or pre-programmed prompt from a remote device or from within the host outlet.

5.) MAC Addressable Outlet that Incorporates a Temperature Sensor

In a Fifth category the MAC addressable electrical outlet as described in 1, 2, 3 and 4 above, jointly, singly or in plurality incorporates temperature sensors and or humidity sensors and or smoke sensors singly or in plurality whose function is to provide information on temperature/humidity/smoke presence within the socket and or externally to the socket.

6) MAC Addressable Outlet that Incorporates an Audio Speaker

In a Sixth category the MAC addressable electrical outlet as described in 1, 2, 3, 4 and 5 above, jointly, singly or in plurality incorporates a loudspeaker whose function is to emit audio signals upon predetermined commands from the electronic circuit within the host outlet, or upon real time commands from a remote device.

7) MAC Addressable Outlet that Incorporates a Microprocessor or Controller

In a Seventh category the MAC addressable electrical outlet as described in 1, 2, 3, 4, 5 and 6 above, jointly, singly or in plurality incorporates a microprocessor or controller in conjunction with an internal or external memory whose function is to receive information from and or provide information or commands to any of the substance within the MAC addressable outlet described in 1, 2, 3, 4, 5 and 6 above The function of the microcontroller is to provide the central intelligence to the outlet, to communicate the commands that provide the functionality to the outlet

8) Electrical Outlet Conjoined with MAC Addressed Node or Hub of Nodes

In an eighth category the electrical outlet is a medium voltage electrical outlet either singly or in plurality incorporating or in conjunction with any type of communication node or point such as but not limited to data, telecom, audio or video outlet, point or node or any communication transition, termination or nodal point, or hub of points where the point or hub of points incorporates a Network Interface with TCP/I.P (or equivalent protocol) uniquely MAC addressable chipset. Again this is designed to communicate with other devices on a physical layer (1) standard of OSI model such as but not limited to Fibre, Coaxial or Twisted Pair; and data link layer (2) standard of the OSI model such as but not limited to Ethernet and token ring or any Wireless Access Platform for Electronic Communications Services Management (WAPECS) band or Bluetooth or any other wireless communication standard where the MAC addressed node described can communicate with and or provide information on the electrical outlet in any way or lend it's address to the electrical outlet in any way or provide or facilitate any of the functionality covered by this application. FIG. 2C illustrates an example such outlet where the power plug socket 8 has an adjacent port or display 10 for data and a wireless communications facility 11.

9) MAC Addressed Node or Hub of Nodes Conjoined with Electrical Outlet via Cable or Connective Pins

In a ninth category is an independent communication point either singly or as part of a hub of outlet devices, nodes or transition points as in the 8th category and designed to plug directly or indirectly into a medium voltage electrical outlet or point either through electrical pins, contacts or any conductive structure of any sort. Again the latter may include any cable or medium that forms part of the physical layer (1) standard of OSI model such as but not limited to medium voltage power, Fibre, Coaxial or Twisted Pair cable, and or data link layer (2) standard of the OSI model such as but not limited to Ethernet, token ring or any Wireless Access Platform for Electronic Communications Services Management (WAPECS) band or Bluetooth or any other wireless communication or any physical layer (1). The interconnected independent communication point can thereby lend its ‘address’ to the interconnected electrical outlet or point and or provide information on or send signals to or receive signals from the electrical outlet or point or provide information on the electrical outlet in any way and or provide for any of the functionality covered by this application. FIG. 2D illustrates an example such outlet as a hub device with a cord-set and plug and where the power plug socket 8 has an adjacent display or port 10 for data and a USB port 12.

A range of different Class B IP addressable outlets embodying the first aspect of the present invention will now be described by way of example.

### 1) Basic MAC Addressable Outlet

This may be a (fixed) medium voltage electrical light fitting or outlet, electrical ‘bus bar’ or modular light fitting or outlet, transition or termination point or nodal point, or any other type of light fitting or switch. It may be a singular or plural outlet. The electrical outlet has a Network Interface such as (but not limited to) an RJ45 or USB socket and an electronic circuit containing a TCP/I.P (or equivalent protocol) unique MAC addressable chip or chipset designed to communicate with other devices over any medium voltage electrical transmission media. The communication may be by using Power Line Connectivity. Alternatively a communication may be by any other physical layer (1) standard of OSI model such as, but not limited to, Fibre, Coaxial or Twisted Pair cable and data link layer (2) standard of the OSI model such as but not limited to Ethernet, token ring or any Wireless Access Platform or Electronic Communications Services Management (WAPECS) band or Bluetooth or infra red or any other wireless communication standard. In general a primary objective of transmitting the framed packets is to control the outlets and provide information on the medium voltage power being propagated. The purpose of the Mac addressable chipset therefore is to act as a communication gateway between a remote PC or Control Panel or command centre and the outlet substance designed herein.

2) MAC Addressable Outlet with Ammeter/Powermeter

In a second category the MAC addressable electrical outlet as described in 1 above singly or in plurality incorporates an ammeter or powermeter (ammeter in conjunction with a voltmeter). The powermeter may also incorporate or work in conjunction with an ohmmeter or any other type of electrical sensor or meter whose function is to provide information on electrical values or characteristics, a primary purpose of which is to measure and detect powerline/outlet performance changes in order diagnose potential problems and to detect changes in appliance power usage e.g when a device goes on standby.

3) MAC Addressable Outlet that Incorporates a Switched Relay

In a third category the MAC addressable electrical outlet as described in 1 and 2 above jointly, singly or in plurality, incorporates a relay (and where it exists an ammeter or powermeter), whose function is to enable or disable the host electrical outlet as described in 1 and 2 either jointly, singly or in plurality at a command or pre-programmed prompt from a remote device or from within the host outlet.

4) MAC Addressable Outlet that Incorporates a Temperature Sensor

In a fourth category the MAC addressable electrical outlet as described in 1, 2 and 3 above, jointly, singly or in plurality incorporates temperature and or humidity sensors and or smoke sensors singly or in plurality whose function is to provide information on temperature/humidity/smoke presence within the outlet and or externally to it.

5) MAC Addressable Outlet that Incorporates an Audio Speaker

In a fifth category the MAC addressable electrical outlet as described in 1, 2, 3 and 4 above, jointly, singly or in plurality incorporates an audio speaker whose function is to emit audio signals upon predetermined commands from the electronic circuit within the host outlet, or upon real time commands from a remote device.

6) MAC Addressable Outlet that Incorporates a Microprocessor or Controller

In a sixth category the MAC addressable electrical outlet as described in 1, 2, 3, 4, and 5 above, jointly, singly or in plurality incorporates a microcontroller in conjunction with an internal or external memory whose function is to receive information from and or provide information or commands to any of the substance/hardware within the MAC addressable outlet described in 1, 2, 3, 4, and 5 above. The function of the microcontroller is to provide the central intelligence to the outlet, to communicate the commands that provide the functionality to the outlet.

### Device Outlets

The electrical network reaches the heart of every appliance. The function of device outlets is to communicate with those appliances through the powerline. Device outlets will vary according each appliance that it serves. There will now be described a typical Device Outlet.

The Device Outlet is an electronic circuit containing a modulation device designed to modulate/demodulate low voltage framed packet communication signals in a manner that allows the signals to be injected, transmitted, received, routed, amplified or otherwise dealt with and transmitted. The data packet is modulated/demodulated in such a way that it may be transmitted between a medium voltage (as defined earlier) electrical power-line and any device where the framed packet is transmitted or received as low voltage. The electronic circuit will also contain a Network Interface with a TCP/I.P (or equivalent protocol) unique MAC addressable chip or chipset. The electronic circuit will be designed to communicate with other devices over any medium voltage electrical transmission media. The communication may be by using Power Line Communications, alternatively the communication may be by any other physical layer (1) standard of OSI model such as, but not limited to, Fibre, Coaxial or Twisted Pair; and data link layer (2) standard of the OSI model such as but not limited to Ethernet, token ring or any Wireless Access Platform for Electronic Communications Services Management (WAPECS) band or Bluetooth or infra red or any other wireless communication standard. In general a primary object of transmitting the framed packets is to communicate with the control panel of the host appliance and or to ‘network’ the appliance to other appliances.

There are now described a number of connective elements that may form part of the system:

### 1) Patch Leads

A patch lead is preferably an interconnect cable designed to transmit a low voltage MAC addressed data packet emitted from a ‘networkable’ device such as but not restricted to a PC, Data or VOIP (Voice Over Internet) Switch, Telephone or any other device that forms part of the physical layer (1) of the OSI model and data link layer (2) standard of the OSI model such as but not limited to Ethernet and being sent to a medium voltage power-line or device or vice-versa, where the interconnect cable incorporates a modulation device designed to modulate/demodulate framed packet communication signals in a manner that allows the signals to be injected, received, routed, amplified, transmitted or be otherwise dealt with between the medium voltage electrical power-line or device and the ‘networkable’ device designed to deal with the packet as a low voltage transmission.

### 2) I/O Modulator

A further component of the system may comprise a modulation device designed to modulate/demodulate framed packet communication signals in a manner that allows the signals to be injected, received, routed, amplified, transmitted or be otherwise dealt with between a medium voltage electrical power-line outlet or device and a ‘networkable’ device such as but not restricted to a PC, Data or VOIP (Voice Over Internet) Switch, Telephone or any other device that forms part of the physical layer (1) and or data link layer (2) of the OSI model designed to deal with the packet as a low voltage transmission where the modulation device contains any type of In/Out interfaces or sockets including but not limited to RJ45, USB, COAX or any other type of physical connection.

3) I/O Modulator with Integrated Cable

A variant of the above is a modulation device designed to modulate/demodulate framed packet communication signals in a manner that allows the signals to be injected, received, routed, amplified, transmitted or be otherwise dealt with between a medium voltage electrical powerline, outlet or device and a ‘networkable’ device such as but not restricted to a PC, Switch, Telephone or any other device that forms part of the physical layer (1) of the OSI model and data link layer (2) standard of the OSI model designed to deal with the packet as a low voltage transmission where the modulation device contains any type of ‘In/out’ port or socket including but not limited to RJ45, USB or Coax or any other physical connection standard and an in/outgoing cable of any length terminated with any type of connective plug or physical connection including but not limited to RJ45, USB or Coax

### 4) NIC Cards

The present invention also provides a Network Interface card or embedded network interface device forming part of the physical layer (1) of the OSI model that incorporates a modulation device designed to modulate/demodulate framed packet communication signals being transmitted to/received from a low voltage source so that they can be transmitted/received as medium voltage signals suitable for transmission on a medium voltage power-line.

Transceivers/Switches/Routers/bridges/hubs

5) Data Switch with Modulator

The present invention also provides a Transceiver, Switch, Hub, Router, Bridge or any such type of device designed to modulate/demodulate framed packet voice, data or other communication signals in a manner that allows low voltage communication signals to be injected, transmitted, received, routed, amplified or otherwise dealt with between and betwixt a medium voltage electrical network as part of the physical layer (1) and data link layer (2) and or network layer (3) of the OSI model and diverse devises attached to the electrical network including but not limited to class A and B electrical outlets described herein, device outlets described herein, PC's, Telecom Switches (including VOoIP), audio or video devices where the communication is dealt with as low voltage. The object of transmitting the framed packets is to provide information between and betwixt diverse devices attached to the medium voltage power line.)

### 6) Data Switch Isolating Medium Voltage Electrical Current

The present invention also provides a Transceiver, Switch, Hub, Router, Bridge or any type of device designed to receive, transmit, route, amplify or otherwise deal with framed packet communication signals on a medium voltage electrical network as part of a physical layer (1) and data link layer (2) and or network layer (3) of the OSI model including but not limited to data, telecom (including VOIP), audio or video packets, where the Transceiver, Switch, Hub, Router, Bridge or device demodulates and isolates the framed packets from the electrical current being transmitted on the medium voltage power line and forms an ‘electrical bridge’ which may also incorporate a controller that can recognise noise and undesired signals affecting the communication and filter out, cancel or otherwise remove them before re-modulating the framed packets for onward transmission on the medium voltage electrical power-line.

7) Data Switch with Medium Voltage Capability

The present invention also provides a Transceiver, Switch, Hub, Router, Bridge or any type of device designed to receive, transmit, route, amplify or otherwise deal with framed packet communication signals on a medium voltage electrical network as part of a physical layer (1) and data link layer (2) and or network layer (3) of the OSI model, including but not limited to data, telecom (including VOIP) audio or video packets, where the Transceiver, Switch, Hub, Router, Bridge or other device works as an integrated part of the medium voltage physical layer and transmits, routes or otherwise deals with the medium voltage electrical current in conjunction with framed packet communications.

The initial preferred form of the system for offices/commercial premises is as a Bus-Bar system ie a modular system of interconnecting conduit with built in copper conductors, designed to form a backbone and horizontal electrical distribution system. The purpose of the structure is deploy the ethernet over power cable topology to transmit power and data simultaneously. The benefit of such system is that different configurations, moves and changes of outlets can take place easily by simply disconnecting and reconnecting the Bus Bars in different configurations and this suits the purpose of the invention well. Domestic wiring systems are far less complex and the unique components of the system can be immediately supplanted directly onto existing wiring.

Where there is a need for transmission of large amounts of data a wholly new design and construction of bus bar will be deployed. There will now be described the new bus bar innovation

The preferred structure of the bus bar will be of thermoplastic structure containing at least three conductors whose purpose is to transmit electrical energy, either with or without an insulating or isolating covering of any description. The conductors will typically be of copper material but may be of any other type of material that can transmit or propagate electrical energy. The purpose of the conductors is to transmit electrical energy and data simultaneously. The centre of the electrical conductors will typically be hollow. The purpose of the hollow or void within the conductor is to transmit data simultaneously but separately to the power transmitted through the structure of the conductor. Data transmission can typically (but not exhaustively) be ‘wireless’, of any Wireless Access Platform or Electronic Communications Services Management (WAPECS) band or Bluetooth or infra red or any other wireless communication standard. However data may also be transmitted through the void over any other physical layer (1) standard of OSI model such as, but not limited to, Fibre, Coaxial or Twisted Pair; and data link layer (2) standard of the OSI model such as but not limited to Ethernet, token ring.

The system uniquely provides I. P addresses to the electrical outlets from which the devices run and in so doing it can communicate with electrical outlets themselves. Using our system it is possible to turn off or reduce power drawn at any branch or outlet on an electrical network to suit the specific needs of users from virtually any location.

A manager will be able to switch off a light on the top floor of Canary Wharf whilst having a cup of cappuccino in his favourite coffee shop or turn off the power being drawn by a vacuum cleaner that someone forgot to unplug, spot an intruder turning on a light or check for dangerous power surges, hotspots and fire hazards, all in the duration of that one cappuccino. In the event of an electrical fire, the system will be able to report the exact starting point and probable cause. The long winded, time consuming, energy audits now almost mandatory for companies in medium to large buildings can be conducted continuously and with consummate ease, since the present system enables reports to be produced at the touch of a button.

Anyone who has walked through a large commercial building or its Communications room late at night and observed the number of electrical devices drawing power needlessly can readily understand the impact that the invention has on wasted energy, cost savings on electricity and consequent financial health of a company and of course the ecological impact of the building. In fact as energy becomes more precious, sooner or later such a system will become mandatory.

In the domestic environment the system of the present invention will immediately facilitate the long awaited intelligent home. It can provide every home with an immediate secure communications network and use that network to control energy to domestic devices, whether digital or analogue. The system allows users to turn on the heating before they arrive home on a cold night and do a host of other simple tasks to make their lives easier and safer. The system can be programmed to turn on or shut an outlet down at specific time or when overloaded, detect inadequately earthed or other types of unsafe installations and switch off an outlet when it detects a device on standby.

Wider and more varied applications include that electricity providers can use a similar system to conserve power on a much wider basis and to remotely read client meters. ‘Black Box’ recorders can be provided which fire investigators could use to accurately pinpoint the course of electrical fire. The system will also provide early warning indicators in the event of electrical fire.

Telecoms benefit too, voice signals can be transmitted easily (in fact the rapid convergence of VOIP (Voice Over Internet Protocol)) lends itself absolutely to this seamless single transmission infrastructure, and since virtually all commercial handsets now require power, it would be readily available from the same media that carries its signal, negating the need for separate telephone and power connection leads.

The system of the present invention has the potential to reduce cabling needs in buildings (and perhaps in the urban area) by up to 75% in addition to its potential to radically reduce the carbon footprint of buildings. It has the power to cause a paradigm shift in the concept of energy management and communication transmission. A description of how the new intelligent multifunctional sockets combined with the User Interface has brought detailed energy monitoring and control together into one place to create a revolutionary smart meter, follows.

### Energy Monitoring Systems (Smart Meters)

Current systems offer energy consumption information on a whole building basis through an inductive core, or specific appliance information through adaptor devices plugged into the mains socket.

The problem with both types of devices is that the information provided is limited in its content to kwh consumed either at a whole building level or a specific appliance or number of appliances (depending on how many appliances can be attached to the adaptor) level.

The power meter in the present invention is able to measure power, phase, phase angle, frequency, volts, current and more. The User Interface displays consumption on a whole building basis, a room by room basis and an individual appliance basis and puts all the information in one place in an easy drill down format. Having all of the information in one place coupled with the depth of detailed information mined allows us to provide far more information, create algorithms that allow us to understand and recognise different appliances and appliance states which in turn facilitate intelligent decision making and many more functions that already make it the most powerful energy mitigating system in the smart meter space.

The addition of the control panel to the energy monitoring and digitally switchable sockets creates a smarter meter that can provide more energy mitigating functionality than any previous system. It may do any of the following:
1. provide status of every socket, on/off/safe/unsafe/standby
2. provide warnings of unsafe or faulty appliances
3. recognise standby and unsafe situations and terminates energy to the attached appliance.
4. provide cost data, watts, kwh, and forecasts running costs of every appliance
5. aggregate appliance data to provide room data
6. aggregate room data to provide whole building data
7. provide real time graph of energy usage, for the whole building
8. provide real time graph of energy usage, for each room
9. provide real time graph of energy usage, for each appliance
10. recognise and defines appliances by name, e.g iron
11. provide instant one touch on/off control of any socket from the home screen
12. provide multi cycle on/off programmable control of each socket
13. log user patterns and appliance behaviour patterns and provide information on deviation
14. make control decisions, based on the appliance state and user behaviour
15. provide simple one page programming/re-programming of individual sockets right up to the whole building level.
16. classify each appliance and the whole building to international standard energy bands and provide information on how to reduce energy use and classification

The resulting system brings central and local control together in a multifaceted system presented on an intuitive User Interface. The Interface provides top down information and control—from a graphical display showing whole building energy consumption, cost and overall diagnostics, through floor and/or room views down to individual appliances showing the name of the appliance and diagnostics i.e that the appliance is functioning well, the user can drill down to any malfunctioning appliance anywhere in the building.

History functions and average appliance consumption functions can provide instant, easy to comprehend information that allows the user to react rapidly to changing appliance or user situations and mitigate at the very earliest opportunity any appliance or human anomalies or changed circumstance.

This type of dynamic system solves many problems and provides unique facilities, for example, that users do not have to switch off sockets individually, one touch on the user interface closes everything down, or according to the program set, automatically when the user is in bed.

### Additional Notes to the Figures

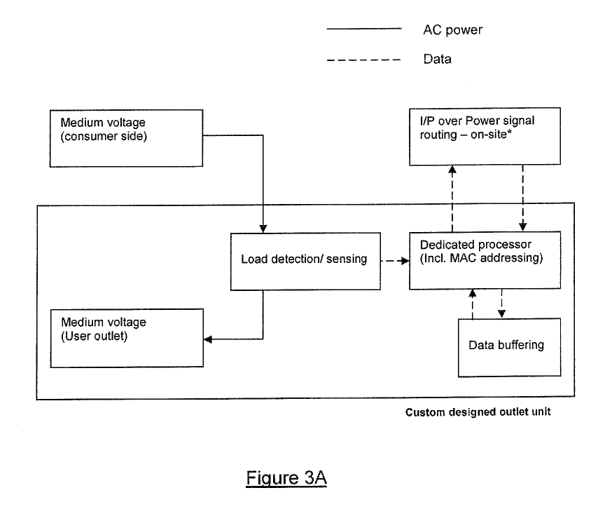

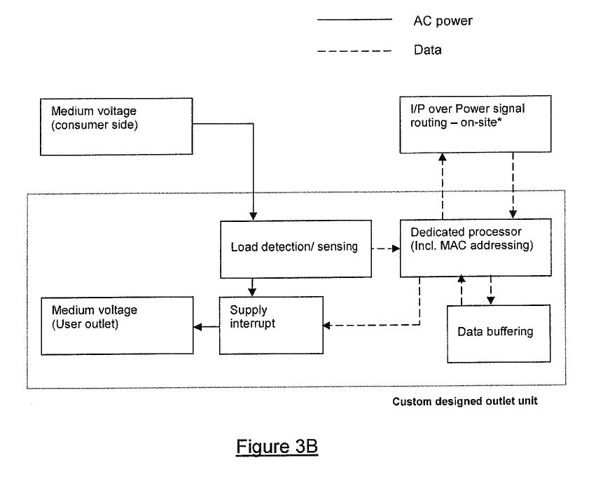

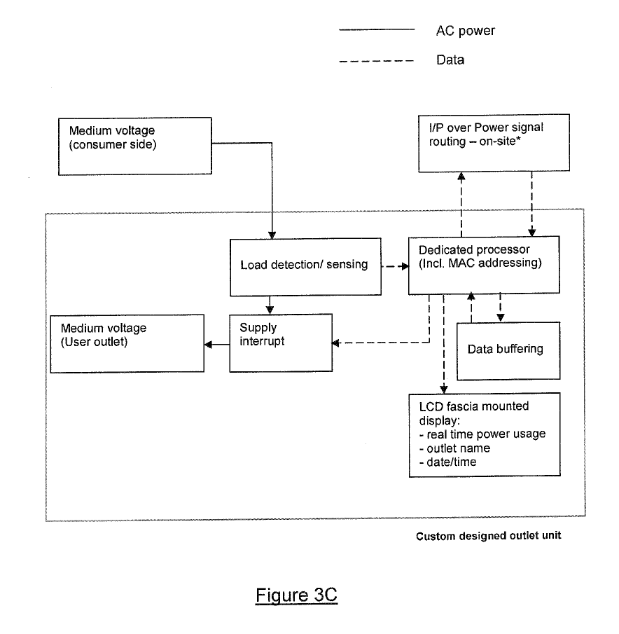

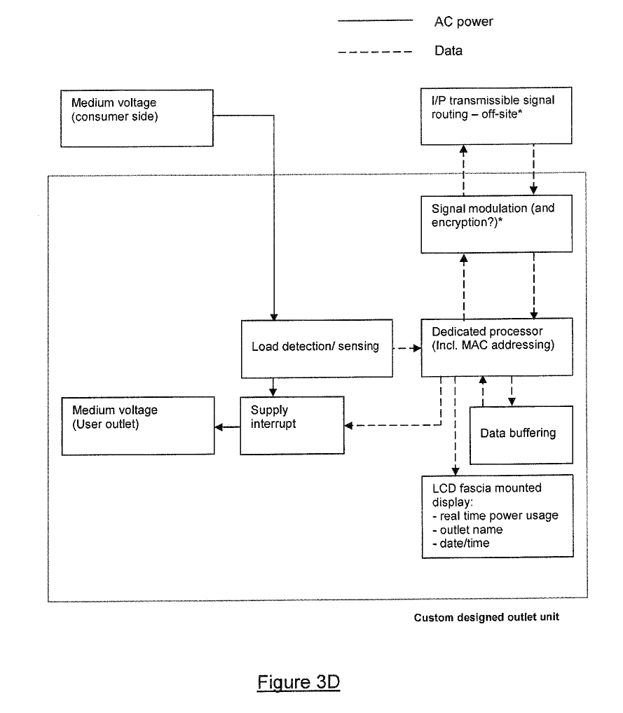

### Notes to FIG. 3A

Connection from power distribution unit (PDU) to user outlet, although sensed, is uninterrupted.
May include fascia mounted display (see FIG. 3C)
On-site reference to be read as the consumer-side medium voltage distributed system for the purposes of IP over Power direct connectivity
Custom designed outlet refers to the incorporation of the components as described above—the footprint of the outlet will conform to existing standard outlets.
May be an Integral Unit: part of a fixed installation or a Discrete Unit: demountable device to be plugged into an existing standard/host outlet

### Notes to FIG. 3B

*See FIG. 3A
May be an Integral Unit: part of a fixed installation or a Discrete Unit: demountable device to be plugged into an existing standard/host outlet

### Notes to FIG. 3C

Display feature would equally apply to the unswitched outlet [FIG. 3A]
*See FIG. 3A
May be an Integral Unit: part of a fixed installation or a Discrete Unit: demountable device to be plugged into an existing standard standard/host outlet

### Notes to FIG. 3D

Transmission may be wireless, hardwired (Cat6, Cat7 or Cat7+), optical or other.
May be an Integral Unit: part of a fixed installation or a Discrete Unit: demountable device to be plugged into an existing standard outlet
Off-site refers to that which is beyond the electrical connectivity of this configuration

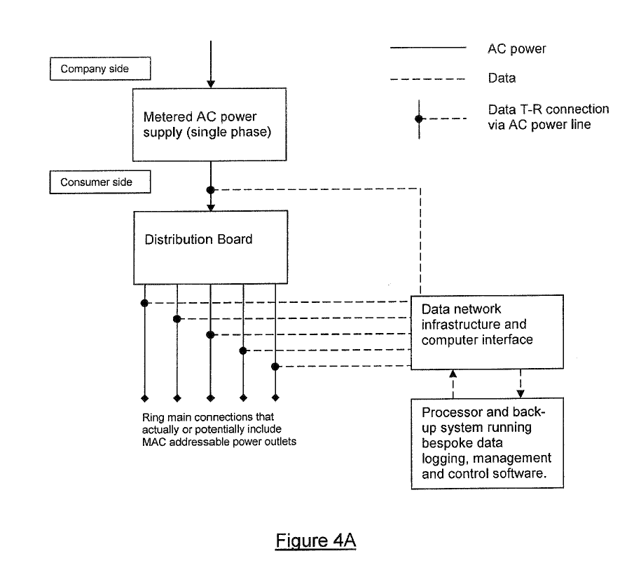

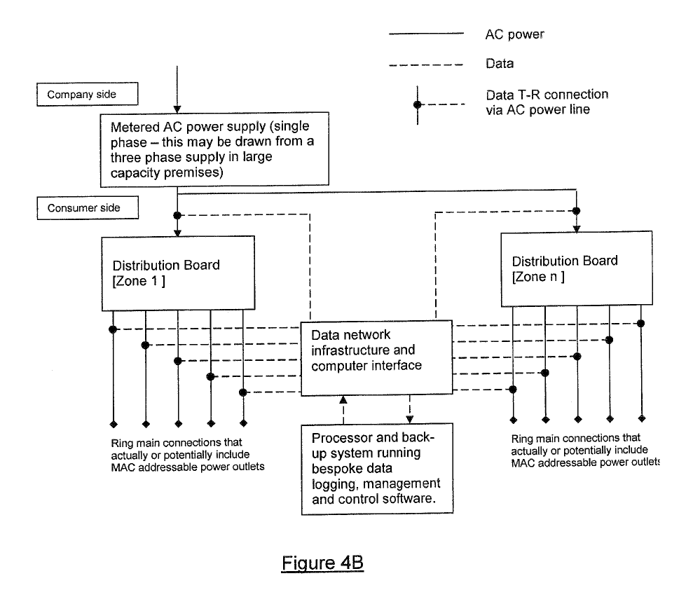

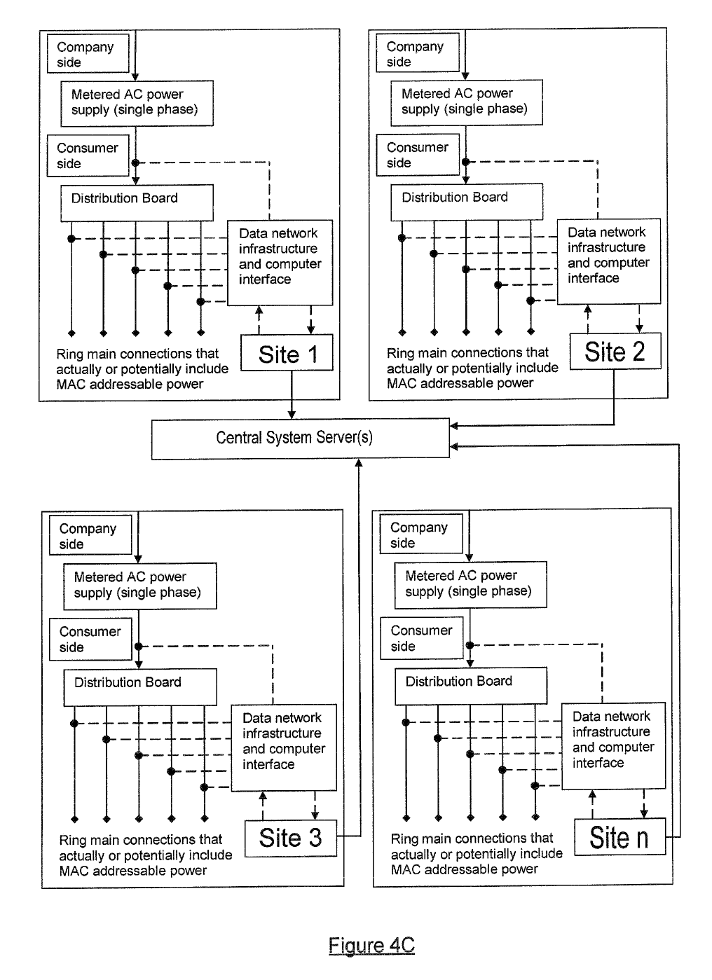

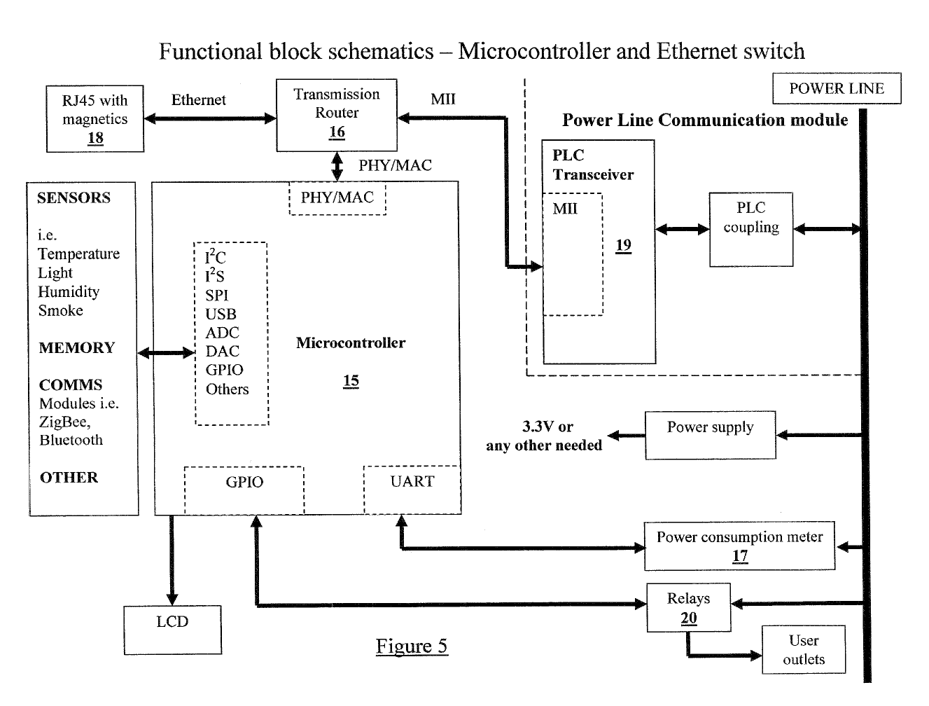

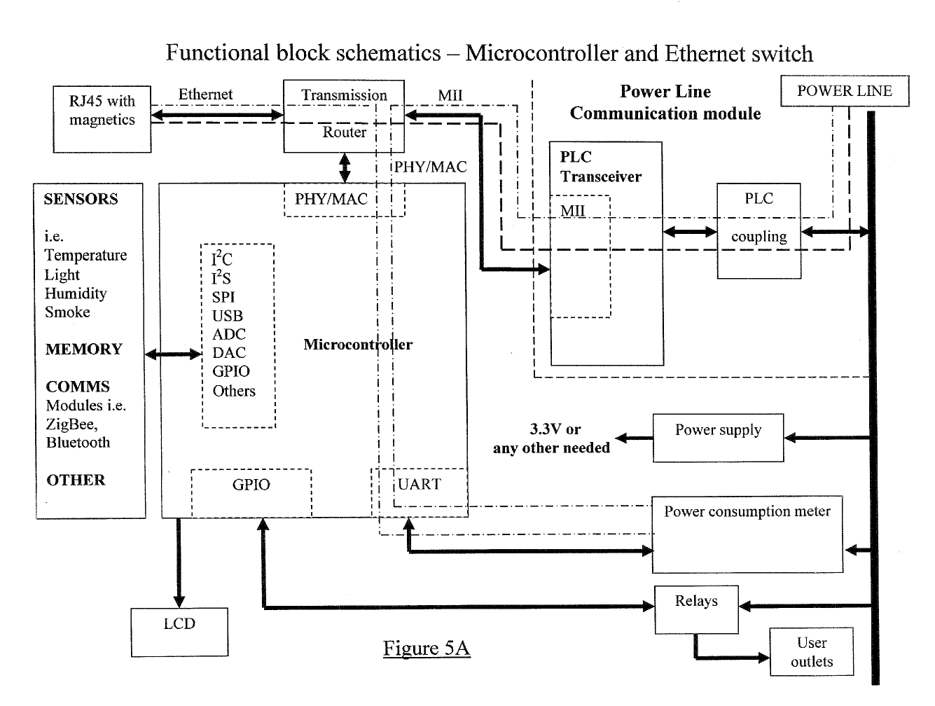

Notes to FIG. 4A
Data transmitter-Receiver (T-R) connection to power ‘field’ made using existing technology. Similar connection required at power outlet points containing addressable module
Data network infrastructure encompasses all forms of local shared data systems using wireless, hardwired (Cat6, Cat7 or Cat7+), optical or other connectivity. This is in addition to all integral hubs, switches and routers and processor/network interfacing
Consumer side distribution system may also include addressable lighting systems that undergo similar treatment as the power outlets (with respect to load monitoring and supply switching)

### Notes to FIG. 4B

Zones can be mapped to the Data Switch/Hub zones or to the power distribution zones (as shown above). If the former, power management by zone will be achieved via the software configuration.
As stated previously, the system described does not preclude use of addressable modules within lighting systems powered from connected distribution boards. This is important since many medium to large installations distribute power discretely by power rating.

### Notes to FIG. 4C

The remote sites in FIG. 4C are of the form in FIG. 4A. These sites may also be multi-zonal as described in FIG. 4B and of course in any combination thereof.
Each site houses a dedicated processor that would link to the central control point. The relationship of control management at the local and central levels can be a matter of client specification. Back-up systems may be deployed centrally and locally.
All configurations of this strata are of a conventional data communications form and are illustrated here to illustrate scope

### Auxiliary Claim Aspects

For centralised control the system suitably has a PLICD remote from the PDTTs and which suitably is programmed to control the PDTT'S. The PLICD may have a computer programme for operating the interactive powerline information and control system (IPLICS), the programme comprising: a code section for transmitting a request for data from the PDTT elements at least in part via the PADN: a code section for receiving and storing the response to said request for data: a code section for transmitting a command to a PDTT element at least in part via the PADN, a code section for receiving a command from a PDTT at least in part via the PADN: a code section for storing information identifying the PDTT element, an address of the PDTT element, and the physical location of the PDTT element.

The computer programme may also comprises a code segment that provides a method to detect and recognise APCS patterns, compare APCS patterns and store them in a database.

The PLICD suitably comprises an interactive graphical user interface (IGUI) that can display data such as but not limited to real time and historical data provided by PDTT's and EA's. An example of real time and historical data is the amount of energy consumed by one or more appliances attached to the network. Further examples of data the PLICD can display include: real time and historical cost of energy consumed by one or more appliances attached to the network; the name and location of one or more appliances attached the network such as but not limited to Kettle and Kitchen; the status of appliances attached to the network such as but not limited to on/off/standby; warnings of unsafe appliance or powerline conditions such as but not limited to earth leakage or high temperature; advice or instructions to the user upon what to do in specific conditions such as but not limited to unsafe conditions; informative data on parameters sensed by one or more PDTT such as but not limited temperature or humidity; in regard to one or more EA's is informative data such as but not limited to the name or channel of a TV program; interactive graphical content through which the user can provide function commands to control one or more PDTT or EA such as but not limited to on/off/standby (a further example of function commands to one or more EA are control commands such as but not limited to change channel or turn up volume.

The PLICD can communicate with and remotely control one or more PDTT or EA elements attached thereto at least partially through the Interactive Graphical User Interface (IGUI). An example of controlling a PDTT or EA through the IGUI is using on screen graphical displays to instruct PDTT or EA behaviour such as but not limited to turn on/turn off. A further example of controlling or instructing

PDTT or EA behaviour would be a string of commands such as turn on 0630 hrs/turn off at 2000 hrs on a specific day or each day for one year. An example of smart functionality and control is that the PLICD can auto instruct PDTT behaviour in certain conditions such as but not limited to non-human intervention in the event of critically unsafe conditions. A further example of auto control in the event of non-human intervention is to turn off when appliance standby or sleep mode is recognised.

The IPLICS system suitably comprises programming with algorithms that can analyse data, interactively display data, make ‘intelligent’ decisions and automatically act upon them in certain conditions such as but not limited to turn off PDTT when appliance standby mode or unsafe condition is detected. The IPLICS system may transmit email alerts to third parties in certain conditions such as but not limited to the fire service or police when an unsafe condition or break in is detected. The system may provide an audio visual exit strategy that moves humans away from danger in the event of critical situations such as fire. This might be by restricting energy to and providing lighting or lighting effects only to the exit routes along with audio sounds or instructions (from PDTT'S).

The system can automatically conserve energy and can automatically improve powerline safety. The IPLICS can provide and interactively display a multiplicity of information in respect of the PADN and attachments such as but not limited to the name, location and status of attached appliance types.

The IPLICS can provide a Local Area Network capable of transmitting audio, video, data and telecom signals and any smart EA such as but not limited to TV, Hi Fi, refrigerator, can be accessed and controlled through the PLICD. The IPLICS can be accessed from any internet enabled location and can be accessed and controlled from anywhere in the world.

The IPLICs suitably has algorithms that can: recognise attached appliance standby mode; act upon the Intelligent decisions' e.g. send command prompts—such command prompts may instruct PDTT or EA behaviour e.g. turn on at 6 pm or turn off on standby. The PLICD can automatically save energy and may receive and transmit real time command prompts from and to a human user through the IGUI e.g. override the system command prompt or turn off a PDTT The user may provide multiple timed command prompts to PDTT's and or EA's e.g. turn on at 6 am and off at 12 pm. The IGUI may provide visual warnings of unsafe conditions at PDTT's to the human user—e.g earth leakage or high temperature. A human user can turn off the unsafe PDTT or EA via the IGUI.

The PLICD can turn off the PDTT in the event that there is no human intervention and the unsafe condition becomes critical.

The PLICD can display real time and historical data on energy used at any or all PDTT's. The PLICD can display real time and historical data on the cost of energy used at any or all PDTT's. The PLICD can jointly and severally display data on smoke, humidity, light or sound at any PDTT and can display the status of any or all PDTT's e.g. on/off or details of an unsafe condition system. The plurality of the elements comprising the IPLICS can automatically conserve energy and can automatically enhance electrical safety. The plurality of the elements comprising the IPLICS can provide a system of remote energy control to electrical appliances from any internet enabled location. The plurality of the elements comprising the IPLICS can provide a system of ‘networking’ any EA attachment—for example an iTV. The PLICD may be a simple computer that is appropriately programmed and networked with the PDTT's. The PLICD can communicate upstream and downstream to PDTT's, EA's and to the Wide Area Network.

The invention provides in one aspect a networked system, wherein the Power and Data transmission terminal is a digitally and/or manually controllable fixed terminal hub that serves as a connection point for electrical transmissions, data transmissions, video and audio transmissions. The Power and Data transmission terminal is able to transmit power to any attached appliance and broadcast multi-sourced data, audio and video over the powerline or wirelessly. The Power and Data transmission terminal suitably further has one or more relays linked to a micro-controller for controlling power supply or switching one or more linked appliances by signals from the micro-controller. The Power and Data transmission terminal suitably further has or is linked to at least one environmental condition sensor (eg for temperature, light, humidity or smoke) the sensor being linked to the micro-controller. Each PDTT may have a display screen and user interface operatively linked to the microcontroller thereof, the user interface being able to receive inputs/intervention from a user and to transfer signals/control signals through the router into the PDTT.

The User Interface may authenticate received signals from the user and/or from a said microcontroller and transfer signals to a database.

A processor of the system suitably has one or more algorithms to profile behaviour (eg on/off status and power usage) of the Power and Data transmission terminals or one or more electrical appliances linked to them or the system and preferably is further configured to take decisions and transmit control signals. The Processor is suitably linked to the user interface and to a database of characteristics of the PDTTs or one or more EAs linked thereto. Suitably the Processor is linked to a transmission router, the router being in hardware or software. Preferably the networked system is a LAN. THE PDTTs are suitably MAC (Media Access Control) addressable power outlets eg a power socket of mains supply in a building or a light fitting of mains supply in a building. The power outlet suitably comprises an electronic circuit with TCP/IP (or equivalent protocol) unique MAC addressable chip or chipset and microprocessor that enables it to be addressed by fixed addressing or roaming addressing. Each MAC addressable power outlet has a unique MAC address in use and can be communicated with. The PDTT may alternatively be an electrical switch or transition point provided with a unique MAC addressable chip or chipset and microprocessor that enables it to be addressed by fixed addressing or roaming addressing.

In one aspect the invention provides a networked system of cable and interconnects to carry electrical power and data the system being adapted to monitor, control and manage the power and having means to provide information on the voltage and electrical current being transmitted by the electrical network or on the power being drawn at an outlet, switch or transition point to a microprocessor/controller (intelligent ‘chipset’).

In another aspect the invention provides a MAC addressable (fixed) medium voltage electrical wall outlet, floor outlet, electrical ‘bus bar’ or modular system outlet, transition or termination point or nodal point, or any other type of consumer side electrical outlet or switch that incorporate a modulation device designed to modulate/demodulate low voltage framed packet communication signals in a manner that allows the signals to be injected, transmitted, received, routed, amplified or otherwise dealt with and transmitted.

The MAC addressable electrical outlet may incorporate a relay whose function is to enable or disable a host electrical outlet to which it is mounted in use at a command or pre-programmed prompt from a remote device or from within the host outlet. It may incorporate a temperature and or humidity sensor and or smoke sensor to provide information on temperature/humidity/smoke presence within the outlet and or externally to it. It suitably incorporates a microcontroller in conjunction with a linked internal or external memory.

In a further aspect the invention provides a Network Interface card or embedded network interface device forming part of the physical layer (1) of the OSI model that incorporates a modulation device designed to modulate/demodulate framed packet communication signals being transmitted to/received from a low voltage source so that they can be transmitted/received as medium voltage signals suitable for transmission on a medium voltage power-line.

The system and each described and/or illustrated component of the system jointly and severally is believed to be inventive and patentable and modifications and variations thereof within the spirit and scope are encompassed within the present application. The inventions embrace any novel and inventive feature or combination of features as disclosed herein.

1. A method of operating an interactive powerline information and control system (IPLICS) comprising of a power and data distribution network (PADN) and plurality of power and data transmission terminals (PDTT) at a range of locations, the PADN supplying low to medium voltage power 5 at 240 v or below, the method comprising; transmitting and receiving a multiplicity of information at least in part over the powerline relating to the plurality of PDTT's and any enabled appliances (EA) connected thereto; harvesting and storing the information in a memory and analysing the harvested information, and using the harvested information to recognise specific conditions, communicate and control the PDTT's and/or any EA's attached thereto at least partially through the powerline.

2. An interactive powerline information and control system (IPLICS) comprising of a power and data distribution network (PADN) and plurality of power and data transmission terminals (PDTT) at a range of locations, the PADN supplying low to medium voltage power at 240 v or below, the system being configured to transmit and receive a multiplicity of information at least in part over the powerline relating to the plurality of PDTT's and any enabled appliances (EA) connected thereto and harvest and store the information in a memory and analyse the harvested information, and use the harvested information to recognise specific conditions, communicate and control the PDTT's and/or any EA's attached thereto at least partially through the powerline.

3. The system of claim 2 wherein the IPLICS further comprises at least one Powerline Information and Control Device (PLICD) with a display screen and a User Interface (eg a GUI).

4. The system of claim 2 wherein the PDTT's comprise a micro-controller and memory and the micro-controller is intelligent, being programmed to send information to and receive information (eg control signals) from an external/remote PLICD or other control centre or user interface.

5. The system of claim 2 wherein the PDTT's comprise a micro-controller and memory and the micro-controller is intelligent, being programmed to carry out local control, responding to one or more sensed conditions locally at the PDTT or EA attached to the PDTT without requiring control communication with a remote controlling device.

6. The method of claim 1 wherein the transmitted information comprises at least one addressing information protocol compatible with Internet Protocols and comprising a respective Unique Serial Number (USN) identifying a PDTT or EA.

7. (canceled)

8. The system of claim 2 wherein each PDTT has wireless communication capabilities.

9. The system of claim 2 wherein each PDTT further comprises at least one external network Interface connector (eg an RJ45 connector) through which the PDTT can communicate with an external data source.

10. The system of claim 2 wherein each PDTT further comprises at least one Intelligent Integrated Circuit (IIC) and the IIC is programmed with program code segments that provide a means of decision making and ‘smart functionality’.

11. The system of claim 10 wherein the smart functionality comprises one or more of: i) recognising the currently most efficient physical media for the transmission route from copper/wired or wireless and routing transmission over the most efficient route; and
regulating and conserving of energy used by the PDTT.

12. The system of claim 11 wherein the conserving of energy is by one or more of: (i) heat to energy conversion (eg by the peltier effect); (ii) light to energy conversion (eg by the photoelectric effect).

13. The system of claim 10 wherein the smart functionality comprises one or more of: i) sensing and measuring physical environmental and electrical properties; (ii) recognising over voltage; (iii) recognising under voltage; (iv) recognising earth leakage; (v) recognising appliance attachment; (vi) restricting energy to attached appliances or turning itself off in response to a specific condition.

14. The system of claim 13 wherein the specific condition is an unsafe condition (eg. over-voltage, under-voltage or earth leakage) or is standby or sleep mode.

15. The system of claim 13 wherein the smart functionality senses one or more of: smoke; humidity; temperature; light; sound; and proximity.

16. The system of claim 13 wherein the smart functionality senses one or more electrical properties (eg. Power factor, active, reactive and apparent power, phase angle, current, VA-volt amps rms, VAR—volt amps reactive, line frequency, voltage, RMS voltage).

17. The system of claim 2 wherein the PDTT comprises a transceiver for transceiving a multiplicity of data to and from the PLICD and other EA's.

18. The system of claim 2 wherein the PDTT comprises an audio transmitter.

19. The system of claim 2 wherein the PDTT provides status and warning indicators.

20. The system of claim 3 wherein the PLICD is programmed for operating the interactive powerline information and control system (IPLICS), the programming comprising: a code section for transmitting a request for data from the PDTT elements at least in part via the PADN: a code section for receiving and storing the response to said request for data: a code section for transmitting a command to a PDTT element at least in part via the PADN, a code section for receiving a command from a PDTT at least in part via the PADN: a code section for storing information identifying the PDTT element, an address of the PDTT element, and the physical location of the PDTT element.

21. The system of claim 20 wherein a computer programme comprises code segments that can parse real time data communicated 5 by PDTT's, timestamp data, store data in a database and correct errors.

22. The system of claim 20 wherein a computer programme comprises a code segment that can send configuration commands to the PDTT, a code segment that can send specific decision making criteria to the PDTT, and a code segment that can receive status updates from the PDTT's.

23. The system of claim 20 wherein a computer programme comprises algorithms that can parse appliance start up and transient electrical load characteristics, structure them and provide an appliance power consumption signature (APCS).

24. The system of claim 23 wherein a computer programme comprises a code segment that can detect and recognise APCS patterns, compare APCS patterns and store them in a database.

25. The system of claim 23 wherein the system further comprises a database that contains live and historical sensed data, configuration settings, APCS patterns and specific decision making criteria communicated by the PDTT's.

26. The system of claim 23 wherein a computer programme comprises code segments that provide smart functionality such as: recognising appliance standby or sleep mode; using APCS patterns to enable appliance discovery; recognition of PCS patterns (eg using a database of such patterns) to assign a name to a discovered appliance; and using APCS patterns to detect appliance standby mode; using the APCS pattern to provide a method of identifying abnormal appliance and or powerline behaviour; using abnormal APCS patterns to provide appliance warning signals such as but not limited to end of efficient life; translating real time and historical energy consumption into monetary cost; and making energy consumption and cost predictions.

27. A Power and Data transmission terminal that is a MAC addressable power outlet, switch or transition point, the Power and Data transmission terminal being adapted to communicate with other devices 5 over any medium voltage electrical transmission media and having a PLC Transceiver and/or wireless communications transceiver, a microcontroller with memory and a power consumption meter.

28. A Power and Data transmission terminal as claimed in claim 27 wherein the terminal further comprises a transmission router between the microcontroller and the PLC Transceiver and/or wireless communications transceiver.

29. A Power and Data transmission terminal as claimed in claim 28 wherein the transmission router receives signal inputs from the microcontroller and from an Ethernet input of the Power and Data transmission terminal and selectively routes those signals to the PLC transceiver.

30. A Power and Data transmission terminal as claimed in claim 27, wherein the terminal comprises at least two of: Electrical, RJ45, USB and Telecom interfaces.

31. A Power and Data transmission terminal as claimed in claim 27, wherein the Power and Data transmission terminal is a wall or floor-mounted/fixed position electrical plug socket or switch unit.

32. A Power and Data transmission terminal as claimed in claim 27, further having an integrated display screen to display the identity thereof and/or the current or power thereat.

33. A Power and Data transmission terminal as claimed in claim 27, wherein the microcontroller is programmed to send information to and receive information (eg control signals) from an external/remote PLICD or other control centre or user interface.

34. A Power and Data transmission terminal as claimed in claim 27, wherein the microcontroller is programmed to carry out local control, responding to one or more sensed conditions locally at the PDTT or EA attached to the PDTT without requiring control communication with a remote controlling device.

35. A Power and Data transmission terminal as claimed in claim 27, wherein the microcontroller is programmed to send information to and receive information (eg control signals) from an external/remote PLICD or other control centre or user interface and is also programmed to carry out local control, responding to one or more sensed conditions locally at the PDTT or EA attached to the PDTT without requiring control communication with a remote controlling device.
